(19) United States
(12) Patent Application Publication
(10) Pub. No.: US 2026/0001037 A1
(43) Pub. Date: Jan. 1, 2026

(54) Membrane Concentration of Dissolved Species

(71) Applicant: Gradiant Corporation, Woburn, MA (US)

(72) Inventors: Siva Kumar Kota, Singapore (SG); Hiep Le, Ferryden Park (AU); Chun Yew Chong, Singapore (SG)

(21) Appl. No.: 19/126,575

(22) PCT Filed: Nov. 8, 2023
(86) PCT No.: PCT/US2023/079132

§ 371 Date: May 1, 2025

Related U.S. Application Data
(60) Provisional application No. 63/423,692, filed on Nov. 8, 2022.

(51) Int. Cl. B01D 61/02; C01C 1/24; C02F 1/44; C02F 1/52; C02F 101/10; C02F 101/20; C02F 103/10; C22B 3/00; C22B 3/22; C22B 3/44

(52) U.S. Cl. CPC B01D 61/026; C01C 1/24; C02F 1/441; C02F 1/5236; C22B 3/22; C22B 3/44; C22B 23/0461; B01D 2315/24; B01D 2317/06; C02F 2101/101; C02F 2101/20; C02F 2103/10

(57) ABSTRACT

A dissolved species (e.g., sulfur) is concentrated from a feed liquid by passing the feed liquid into a first reverse-osmosis module of a first reverse-osmosis assembly, where the feed liquid is separated with a membrane to produce a permeate and a concentrate solution. In a de-supersaturation module, dissolved components are precipitated from the concentrate solution to produce solid precipitates and a de-supersaturated concentrate solution, which is passed to a second reverse-osmosis assembly, where the de-supersaturated concentrate solution is separated with a membrane to produce a permeate and a concentrated brine. In a polishing module, the permeates from the first and second reverse-osmosis assemblies are further purified to produce a polished permeate and a concentrate solution that is recycled back to the retentate side of the first reverse-osmosis module of the first reverse-osmosis assembly where it mixes with the feed liquid, and the polished permeate is extracted from the polishing module.

### BACKGROUND

The discussion of the background state of the art, below, may reflect hindsight gained from the disclosed invention(s); and these characterizations are not necessarily admitted to be prior art.

Mining of metals, such as nickel and cobalt, typically produces effluent with significant dissolved concentrations of the metal and sulfate ions. Sulfate ions (SO₄²⁻) are commonly released from metal ores during the metal extraction process, as ore bodies frequently include sulfidic minerals that oxidize during the extraction process to produce sulfate ions.

Mining effluent ore is typically treated with a thermal-based separation/concentration technology, such as a mechanical vapor compressor, or a membrane-based technology, such as forward osmosis, vibrational osmosis, or membrane distillation, to separate the water for potential reuse while concentrating and precipitating dissolved components for recovery and for more-efficient and safer waste storage and disposal. Sulfates, such as ammonium sulfate, tend to be highly soluble in water, however, which can result in high sulfate concentrations in the effluent, and which can be problematic as the separation process can result in precipitation (scaling) with changes in concentration, temperature, pressure, etc., which can foul the separation structures (e.g., membranes) used in the thermal-based effluent separation/concentration, reducing the efficiency of the separation structures.

### SUMMARY

Methods and apparatus for efficiently separating sulfur (sulphur) compounds and other dissolved species from solvent (e.g., water) with reduced risk of scaling are described herein, where various embodiments of the apparatus and methods may include some or all of the elements, features, and steps described below.

A system for concentrating dissolved species from a feed liquid includes a source of feed liquid, a first reverse-osmosis assembly, a de-supersaturation module, a second reverse-osmosis assembly, and a polishing module.

The first and second reverse-osmosis assemblies each include a first reverse-osmosis module that defines a chamber and includes (a) a membrane contained in the chamber and dividing the chamber into a permeate side and a retentate side and configured to selectively pass solvent from the retentate side through the membrane to the permeate side; (b) an inlet configured for liquid flow into the retentate side; (c) an outlet on the retentate side for releasing a concentrate solution; and (d) a permeate outlet on the permeate side for releasing the permeate.

The first reverse-osmosis module of the first reverse-osmosis assembly is configured to receive the feed liquid from the source of feed liquid. Further, the membrane of the first reverse-osmosis module of the first reverse-osmosis assembly is configured to selectively pass solvent from the feed liquid in the retentate side through the membrane to the permeate side of the first reverse-osmosis module of the first reverse-osmosis assembly.

The de-supersaturation module is configured to precipitate solids from the concentrate solution from the first reverse-osmosis assembly to produce precipitated solids and a de-supersaturated concentrate solution. The de-supersaturation module includes a de-supersaturation inlet in fluid communication with the retentate outlet of the first reverse-osmosis module of the first reverse-osmosis assembly and configured to receive the concentrate solution from the retentate outlet of the first reverse-osmosis module of the first reverse-osmosis assembly, a precipitate outlet for releasing the precipitated solids, and a de-supersaturated-concentrate outlet for releasing the de-supersaturated concentrate solution from the de-supersaturation module.

The first reverse-osmosis module of the second reverse-osmosis assembly is configured to receive the de-supersaturated concentrate solution from the de-supersaturation module. Further, the membrane of the first reverse-osmosis module of the second reverse-osmosis assembly is configured to selectively pass solvent from the de-supersaturated concentrate solution in the retentate side through the membrane to the permeate side of the first reverse-osmosis module of the second reverse-osmosis assembly.

The polishing module includes a polishing inlet in fluid communication with the permeate outlet of the first reverse-osmosis module of each of the first and second reverse-osmosis assemblies. The polishing module is configured to receive the permeate of the first and second reverse-osmosis assemblies and to further purify the permeates to produce a polished liquid as well as a concentrate solution, a polished-liquid outlet for releasing the polished liquid, and a concentrate outlet in fluid communication with the first-stage inlet for recycling the concentrate solution from the polishing module back to the first reverse-osmosis assembly.

In a method for concentrating dissolved species, such as a sulfur compound, from a feed liquid, the feed liquid that includes the dissolved species passes into a first reverse-osmosis module of a first reverse-osmosis assembly. In the first reverse-osmosis module of the first reverse-osmosis assembly, the feed liquid is separated with a membrane, wherein a permeate flows through the membrane to a permeate side of the first reverse-osmosis module of the first reverse-osmosis assembly, while a concentrate solution is retained on a retentate side on an opposite side of the membrane from the permeate side in the first reverse-osmosis module of the first reverse-osmosis assembly.

The permeate from the first reverse-osmosis assembly passes from the permeate side of the first reverse-osmosis module to a polishing module, while the concentrate solution from the first reverse-osmosis assembly passes from the retentate side of the first reverse-osmosis module to a de-supersaturation module. In the de-supersaturation module, dissolved components from the concentrate solution are precipitated to produce solid precipitates and a de-supersaturated concentrate solution. The solid precipitates are discharged from the de-supersaturation module. The de-supersaturated concentrate solution passes from the de-supersaturation module to a first reverse-osmosis module in the second reverse-osmosis assembly.

In the first reverse-osmosis module of the second reverse-osmosis assembly, the de-supersaturated concentrate solution is separated with a membrane, wherein a permeate flows through the membrane to a permeate side of the first reverse-osmosis module of the second-stage reverse-osmosis assembly, while a concentrated brine is retained on a retentate side on an opposite side of the membrane from the permeate side in the first reverse-osmosis module of the second-stage reverse-osmosis assembly. The permeate passes from the permeate side of the first reverse-osmosis module of the second reverse-osmosis assembly to the polishing module, while the concentrated brine is extracted from the second reverse-osmosis assembly.

In the polishing module, the permeate from the first reverse-osmosis assembly and the permeate from the second reverse-osmosis assembly are further purified to produce a polished permeate and a concentrate solution that is less pure than the polished permeate. The concentrate solution is recycled from the polishing module back to the retentate side of the first reverse-osmosis module of the first reverse-osmosis assembly where it mixes with the feed liquid, and the polished permeate is extracted from the polishing module.

In the above apparatus and methods, one or both of the first and second reverse-osmosis assemblies can further include a second reverse-osmosis module connected in series with the first reverse-osmosis module.

Accordingly, the concentrate solution/brine is treated with an intermediate de-supersaturation step to de-supersaturate the brine solution before concentrating the brine solution further to a desired final concentration. The methods and apparatus can be used to concentrate a brine (e.g., a nickel brine) from effluent from a mining operation to reduce the volume of concentrated brine for disposal and to harvest clean permeate for potential reuse. Using these methods and apparatus, in particular exemplifications, the concentration of dissolved ions in nickel brine can be increased from an initial concentration of less than 10% by weight or less than 20% by weight to a final concentration of 43% by weight.

This solution can maximize brine concentration, maximize water recovery, minimize wastewater for disposal, generate clean permeate for potential reuse, and be implemented with low capital and operating costs.

### BRIEF DESCRIPTION OF THE DRAWINGS

FIG. 1 is a schematic illustration of a system 10 for efficiently separating sulfur compounds from effluent, e.g., from mining. The system 10 includes a first reverse-osmosis assembly 14, a de-supersaturation module 28, a second reverse-osmosis assembly 36, and a polishing module 26 joined via conduits 13 for liquid (and/or solids) flow (shown with arrows) therebetween.

FIG. 2 is a schematic illustration of a reverse-osmosis module 27 as may be found in the first reverse-osmosis assembly 14 and/or in the second reverse-osmosis assembly 36.

FIG. 3 schematically illustrates a first-stage reverse-osmosis module 27′ joined in series with a second-stage reverse-osmosis module 27″ as may be found in the first reverse-osmosis assembly 14 and/or in the second reverse-osmosis assembly 36, wherein the first-stage concentrate solution 17′ (in the first reverse-osmosis assembly 14) or the first-stage concentrated brine 46′ (in the second reverse-osmosis assembly 36) from the first-stage reverse-osmosis module 27′ is fed as the feed into the retentate side 20″ of the second-stage reverse-osmosis module 27″, while second-stage permeate 15″/44″ (in the first reverse-osmosis assembly 14/in the second reverse-osmosis assembly 36) passes from the permeate side 22″ of the second-stage reverse-osmosis module 27″ through the first-stage reverse-osmosis module 27′ with additional permeate that has passed through the first-stage reverse osmosis membrane 18′ as further-purified first-stage permeate 15′/44′.

FIG. 4 schematically illustrates an alternative configuration of a first-stage reverse-osmosis module 27′ joined in series with a second-stage reverse-osmosis module 27″ as may be found in the first reverse-osmosis assembly 14 and/or in the second reverse-osmosis assembly 36, wherein the first-stage permeate 15/44′ (in the first reverse-osmosis assembly 14/in the second reverse-osmosis assembly 36) is fed as the feed into the retentate side 20″ of the second-stage reverse-osmosis module 27″, while the second-stage concentrate solution 17″ (in the first reverse-osmosis assembly 14) or the second-stage concentrated brine 46″ (in the second reverse-osmosis assembly 36) passes from the retentate side 20″ of the second-stage reverse-osmosis module 27″ through the permeate side 22′ of the first-stage reverse-osmosis module 27′ with additional permeate that has passed through the first-stage reverse-osmosis membrane 18′ as the first-stage permeate 15′/44′ and recirculated back to the second-stage reverse-osmosis module 27″.

In the accompanying drawings, like reference characters refer to the same or similar parts throughout the different views; and apostrophes are used to differentiate multiple instances of the same or similar items in different iterations. The drawings are not necessarily to scale; instead, an emphasis is placed upon illustrating particular principles in the exemplifications discussed below.

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

Unless otherwise herein defined, used, or characterized, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially (though not perfectly) pure, as practical and imperfect realities may apply; e.g., the potential presence of at least trace impurities (e.g., at less than 1 or 2%) can be understood as being within the scope of the description. Likewise, if a particular shape is referenced, the shape is intended to include imperfect variations from ideal shapes, e.g., due to manufacturing tolerances. Percentages or concentrations expressed herein can be in terms of weight or volume. Processes, procedures, and phenomena described below can occur at ambient pressure (e.g., about 50-120 kPa—for example, about 90-110 kPa) and temperature (e.g., −20 to 50° C.—for example, about 10-35° C.) unless otherwise specified or implied.

Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein should be interpreted accordingly.

Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified.

The terminology used herein is for the purpose of describing particular embodiments and is not intended to limit exemplary embodiments. As used herein, singular forms, such as those introduced with the articles, “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

Additionally, the various components identified herein can be provided in an assembled and finished form; or some or all of the components can be packaged together and marketed as a kit with instructions (e.g., in written, video, or audio form) for assembly and/or modification by a customer to produce a finished product.

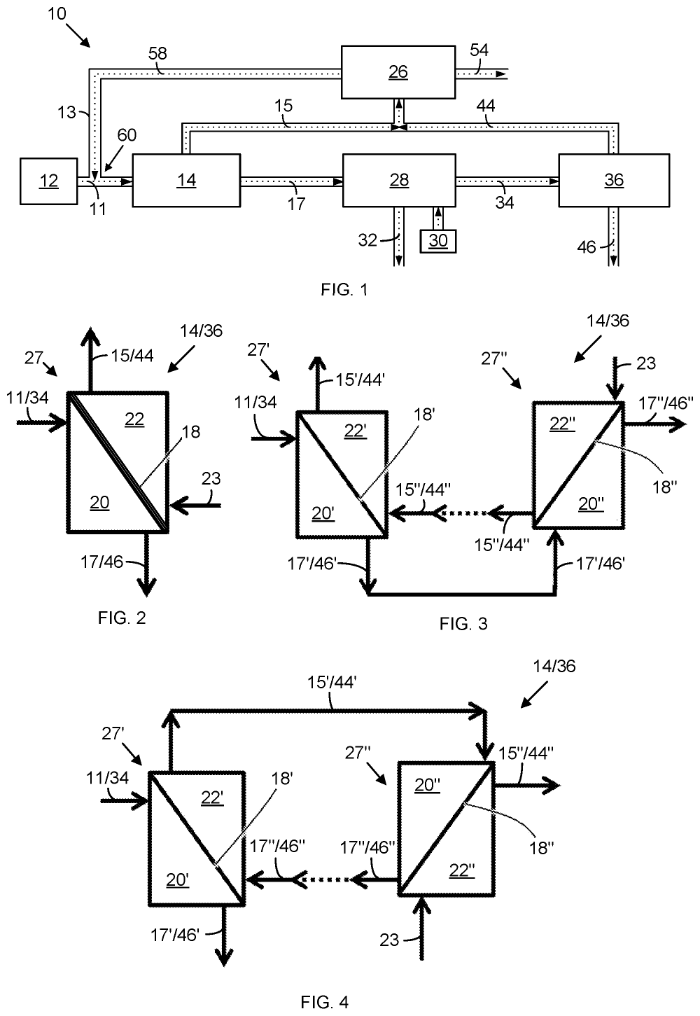

A schematic illustration of a system 10 for concentrating dissolved species, such as sulfur, from a feed liquid (e.g., effluent from nickel and/or cobalt mining), is illustrated in FIG. 1. The system includes a first reverse-osmosis assembly 14, a de-supersaturation module 28, a second reverse-osmosis assembly 36, and a polishing module 26, all conducted via conduits 23 for liquid flow therebetween.

The feed liquid 11 (e.g., pre-treated nickel brine from a nickel mine) is fed from a source 12 (e.g., a holding tank) via a conduit 13 into a first reverse-osmosis assembly 14, which produces a low-salinity permeate 15 and higher-salinity concentrate solution 17. The permeate 15 flows from the first reverse-osmosis assembly 14 to a de-supersaturation module 28, which produces precipitated solids 32, which can be collected and reused or disposed of, and a de-supersaturated concentrate solution 34. The de-supersaturated concentrate solution 34 is passed from the de-supersaturation module 28 to a second reverse-osmosis assembly 38, which produces a permeate 44 and a concentrated brine 46. The permeate 15 from the first reverse-osmosis assembly 14 and the permeate 44 from the second reverse-osmosis assembly 36 are merged and fed through a polishing module 26 for further separation, which produces a polished liquid 54 and a higher-salinity concentrate solution 58.

The first reverse-osmosis assembly 14 and the second reverse-osmosis assembly 36 both include one or more reverse-osmosis modules 27, as shown in FIGS. 2-4. Each reverse-osmosis module 27 defines a chamber that contains one or more reverse-osmosis membranes 18, which can be the same as membranes conventionally used for desalinating seawater. The reverse-osmosis modules 27 can be, e.g., in the form of a spiral-wound membrane configuration, in the form of a hollow fiber, or in a flat-plate configuration. The membrane(s) 18 separate(s) the chamber into a retentate side 20, into which the feed liquid is fed, and a permeate side 22 and allow for the passage of solvent (e.g., water) therethrough from the retentate side 20 into the permeate side 22, while blocking passage of dissolved ions on the retentate side 20.

On the retentate side 20 of the reverse-osmosis module 27, the dissolved components in the liquid in the retentate side 20 (e.g., the feed liquid 11) are concentrated up to a concentration before precipitation occurs in the bulk solution. The reverse-osmosis modules 27 can utilize a process known as counter-flow reverse osmosis (CFRO). The CFRO process, which is further described in WO 2018/075637 A1 and US 2018/0104649 A1, is a non-evaporative, membrane-based process for desalinating brines. Similar to a conventional reverse osmosis (RO) process, the CFRO process uses hydraulic pressure to drive water across a semipermeable membrane 18 while removing dissolved salts from the liquid in the retentate side 20. The hydraulic pressure in the stream of liquid on the retentate side 20 is sufficiently high to overcome the osmotic pressure difference across the membrane 18 between the retentate and permeate streams.

In comparison with a conventional RO process, which produces a permeate of low salinity, CFRO uses a stream of saline solution 23 known as the sweep solution, flowing into and through the permeate side 20 of the reverse-osmosis module 27. The sweep solution 23 can be fed, e.g., via a pump (not shown—the flow of all streams described herein can be driven by pumps). This configuration greatly reduces the osmotic pressure differences between the stream of feed liquid 11 and the stream of permeate 15, which lowers the hydraulic pressure required to drive permeate flow across the membrane 18. The produced permeate 15 extracted from the permeate side 22 of the reverse-osmosis module 30 downstream from where the sweep solution 23 is introduced includes the permeate that passes through the membrane 18 as well as the sweep solution 23. A concentrate solution 17 is extracted from the retentate side 20 downstream from where the feed liquid 11 is introduced. With the CFRO configuration, ultra-saline feeds can be treated at low enough hydraulic pressures with just the use of standard RO equipment.

A CFRO configuration with at least two reverse-osmosis modules 27 in one or both of the first- and second-stage reverse-osmosis assemblies 14 and 36, as shown in FIG. 3, can be used when the reverse-osmosis module 27 uses membranes in the form of hollow fibers or flat plates. The sweep solution 23 flows through the permeate side 22″ of the second RO module 36 and then through the permeate side 22′ of the first RO module 14 counter-current to the flow of the feed liquid 11/34, which can take a variety of forms as is herein described and illustrated. The fully diluted sweep solution/permeate 15′/44′ is then fed to the polishing module 26.

In an alternative configuration, shown in FIG. 4, the first reverse-osmosis module 27′ is joined in series with the second reverse-osmosis module 27″ via a different combination of flows. In particular, the permeate 15′ or 44′ (from the first reverse-osmosis module 27′ in the first reverse-osmosis assembly 14 or from the second reverse-osmosis assembly 36) is fed as the feed into the retentate side 20″ of the second reverse-osmosis module 27″, while the concentrate solution 17″ (in the first reverse-osmosis assembly 14) or the second-stage concentrated brine 46″ (in the second reverse-osmosis assembly 36) passes from the retentate side 20″ of the second reverse-osmosis module 27″ through the permeate side 22′ of the first reverse-osmosis module 27′ with additional permeate that has passed through the reverse-osmosis membrane 18′ of the first reverse-osmosis module 27″ as the permeate 15′/44′ from the first reverse-osmosis module 27′ and recirculated back to the second reverse-osmosis module 27″. In this case, the permeate 15″/44″ from the second reverse-osmosis module 27″ is then fed to the polishing module 26 for further separation.

The concentrate solution 17 (with a higher concentration of dissolved ions than the feed liquid 11) from the first reverse-osmosis assembly is fed via a conduit 13 to a de-supersaturation module 28 for a second step in the separation/concentration process, wherein the first-stage concentrate solution 17 is diverted to a precipitation tank and de-supersaturated by injecting seeds from a seed source 30 into the first-stage concentrate solution 17. The de-supersaturation module 28 can be a conventional reactor with seeding or a fluidized bed crystallizer with seeding. The seeds can be selected from salts, such as Na₂S; calcium sulfate; or metal sulfates, sulfides (e.g., H₂S), or oxides. The seeds can be produced via precipitation, or they can be procured in salt form. The seeds initiate precipitation of precipitable salts from the concentrate solution 17 from the first reverse-osmosis assembly and thereby de-supersaturate the concentrate solution 17, producing precipitated solids 32 and a de-supersaturated concentrate solution 34. The precipitated solids 32 can then be removed using, e.g., a lamella clarifier or a high-rate solids contact clarifier.

The de-supersaturated concentrate solution 34 is fed from the de-supersaturated-concentrate outlet of the de-supersaturation module 28 through a conduit 13 to a second reverse-osmosis assembly 36, where it enters on the retentate side 40 of a first reverse-osmosis module 27. The second reverse-osmosis assembly 36 can be similar to the first reverse-osmosis assembly 14 and can likewise utilize the CFRO process. In the second reverse-osmosis assembly 36, solvent (e.g., water) again selectively passes from the de-supersaturated-concentrate solution 34 through a RO membrane 18 to the permeate side 42 of the chamber in the second-stage RO assembly 36, as the remnant of the de-supersaturated-concentrate solution 34 is further concentrated to produce a concentrated brine on the second-stage retentate side 40 with a desired final brine concentration. The de-supersaturation of the first-stage concentrate solution 17 in the de-supersaturation module 28 helped remove precipitable salts so that further brine concentration during this second-stage reverse-osmosis process can be done without the formation of scales, which may scale the RO membranes 18 during the brine-concentration process. The reverse-osmosis process in the second reverse-osmosis assembly accordingly produces the following two product streams: a second permeate 44 and the concentrated brine 46. The concentrated brine 46 can be disposed of, while the second permeate 44 with its lower salinity will be combined with the first permeate 15 via a juncture of connecting conduits 13 en route to the polishing module 26.

The permeates 15 and 44 are fed through a polishing inlet into the polishing module 26, which can be a conventional reverse-osmosis module. In the polishing module 26, the permeates are subject to a separation process that produces a concentrate solution 48 and a polished permeate 50 with a reduced concentration of dissolved ions in comparison with the concentrate solution 48 produced in the polishing module 25. The polishing module also includes a polished-liquid outlet for releasing the polished liquid 54, and a concentrate outlet in fluid communication with the first-stage inlet 16 for recycling the concentrate solution 58 from the polishing module 26 back to the first-stage reverse-osmosis module 14. The polished liquid 54 is released through the polished-liquid outlet for potential reuse, while the concentrate solution 58 produced in the polishing module 26 is extracted from the polishing module 26 through the concentrate outlet and recycled through a conduit 13 to a junction 60 with the conduit 13 for the feed liquid 11 entering the first reverse-osmosis assembly 14 so that the concentrate solution 58 from the polishing module 26 is fed together with (or as an alternative to) the feed liquid 11 into the first reverse-osmosis assembly 14.

### Exemplification:

Three wastewater streams were processed with an exemplification of the methods and apparatus described above. The details of each of these streams are provided below.

### Case Study 1:

The first case study used wastewater effluent from a nickel-mining storage tank, identified as “nest liquor small” as the feed liquid 11. The feed liquid parameters were pH 7.0 and TDS of 50,000 mg/L. The nest liquor small was concentrated in the system 10 from a starting salinity of 6.5 weight percent of solute per weight of solution (w/w %) to a concentration of 25 w/w % at the first reverse-osmosis (RO) assembly 14. The first-stage RO module 14 was operated at room temperature, using 1,000 psi (6.9 MPa) operating pressure. Thereafter, the first-stage concentrate solution 17 was de-supersaturated in the de-supersaturation module 28 using a seed in the form of sodium sulfite (Na₂S), which acts as a reagent, reacting with one or more metals to form a metal sulfide. Following which, the de-supersaturated concentrate solution 34 was further concentrated in the second reverse-osmosis assembly 36 up to a final concentration of 43 w/w %. Table 1, below, shows the analysis results for the untreated nest liquor small and concentrated brine 46 at 43 w/w %.

TABLE 1

| | | Feed - Lab | Concentrated |
|---|---|---|---|
| Parameter | Unit | measurement | feed |
| pH | — | 7.0 | 7.23 |
| Conductivity | μS/cm | 123,050 | 589,600 |
| TDS | mg/l | 50,000 | 336,000 |
| TSS | mg/l | 44 | — |
| Sulfate as SO4 | mg/l | 48,168 | 338,532 |
| Chloride as Cl | mg/l | 510 | 3,463 |
| Calcium as Ca | mg/l | 131 | 927 |
| Magnesium as Mg | mg/l | 5.10 | ND |
| Sodium as Na | mg/l | 1,087 | 5,915 |
| Potassium as K | mg/l | 3.70 | 21.2 |
| Aluminum as Al | mg/l | ND | ND |
| Arsenic as As | mg/l | 0.049 | 0.58 |
| Beryllium as Be | mg/l | ND | ND |
| Barium as Ba | mg/l | 0.024 | 1.00 |
| Bismuth as Bi | mg/l | ND | ND |
| Cadmium as Cd | mg/l | ND | 0.11 |
| Chromium as Cr | mg/l | 0.001 | 0.65 |
| Cobalt as Co | mg/l | 168 | 410 |
| Copper as Cu | mg/l | 11.7 | 87.5 |
| Lead as Pd | mg/l | 0.079 | 0.52 |
| Lithium as Li | mg/l | ND | ND |
| Manganese as Mn | mg/l | 0.492 | 2.76 |
| Molybdenum as Mo | mg/l | 0.147 | 0.78 |
| Nickel as Ni | mg/l | 149 | 1,240 |
| Selenium as Se | mg/l | 0.083 | 1.20 |
| Silver as Ag | mg/l | ND | ND |
| Strontium as Sr | mg/l | 0.529 | 3.96 |
| Boron as B | mg/l | 4.27 | 18.1 |
| Iron as Fe | mg/l | ND | 0.69 |
| Reactive silica | mg/L | — | — |
| Ammonia as N | mg/l | 12,250 | 96,000 |
| Nitrite as N | mg/l | <0.1 | <6.09 |
| Nitrate as N | mg/l | 2.99 | <4.52 |
| Nitrite + Nitrate as N | mg/l | <3.0 | <10.6 |
| Total Kjeldahl Nitrogen as | mg/L | — | — |
| N | | | |
| Total Nitrogen as N | mg/L | — | — |
| Total Phosphorus as P | mg/L | — | — |
| TOC | mg/l | 23.7 | 95.5 |
| Hydroxide Alkalinity | CaCO₃ | <1 | — |
| | mg/l | | |
| Carbonate Alkalinity | CaCO₃ | <1 | — |
| | mg/l | | |
| Bicarbonate Alkalinity | CaCO₃ | 645 | — |
| | mg/l | | |
| Total Alkalinity | CaCO₃ | 645 | — |
| | mg/l | | |

### Case Study 2:

For the feed liquid 11, the second case study used wastewater effluent from a nickel-mining storage tank, identified as “nest liquor large.” The feed liquid parameters were pH 7.0 and total dissolved solids (TDS) of 50,000 mg/L. The nest liquor large was concentrated in the system 10 from a starting salinity of 7.5 w/w % to 21 w/w % at the first reverse-osmosis assembly 14. The first reverse-osmosis assembly 14 is operated at room temperature, using 1000 psi (6.9 MPa) operating pressure. Subsequently, the concentrated solution 17 from the first reverse-osmosis assembly 14 is de-supersaturated in the de-supersaturation module 28 using Na₂S, followed by further concentration using the second reverse-osmosis assembly 36. Further concentration of the de-supersaturated concentration solution 34 using the second reverse-osmosis assembly 36 further concentrates the brine solution 46 to a final concentration of 43 w/w %. Table 2, below, shows the analysis results for untreated nest liquor large and the concentrated brine 46 at 43 w/w %.

TABLE 2

| | | Lab | Concentrated |
|---|---|---|---|
| Parameter | Unit | measurement | feed |
| pH | — | 7.1 | 7.51 |
| Conductivity | μS/cm | 149,200 | 620,400 |
| TDS | mg/l | 50,000 | 481,000 |
| TSS | mg/l | 5 | — |
| Sulfate as SO4 | mg/l | 56,938 | 343,350 |
| Chloride as Cl | mg/l | 349 | 1,650 |
| Calcium as Ca | mg/l | 83.6 | 430 |
| Magnesium as Mg | mg/l | 3.96 | ND |
| Sodium as Na | mg/l | 741 | 4,111 |
| Potassium as K | mg/l | 10.6 | 28.6 |
| Aluminum as Al | mg/l | ND | ND |
| Arsenic as As | mg/l | 0.237 | 0.75 |
| Beryllium as Be | mg/l | ND | ND |
| Barium as Ba | mg/l | 0.034 | 0.49 |
| Bismuth as Bi | mg/l | ND | ND |
| Cadmium as Cd | mg/l | ND | 0.22 |
| Chromium as Cr | mg/l | ND | 1.12 |
| Cobalt as Co | mg/l | 111 | 172 |
| Copper as Cu | mg/l | 8.15 | 72.8 |
| Lead as Pd | mg/l | 0.143 | 0.18 |
| Lithium as Li | mg/l | ND | ND |
| Manganese as Mn | mg/l | 0.212 | 0.80 |
| Molybdenum as Mo | mg/l | 0.18 | 0.63 |
| Nickel as Ni | mg/l | 1,616 | 2,895 |
| Selenium as Se | mg/l | 0.042 | 1.34 |
| Silver as Ag | mg/l | ND | ND |
| Strontium as Sr | mg/l | 0.358 | 1.88 |
| Boron as B | mg/l | 3.39 | 10.9 |
| Iron as Fe | mg/l | ND | ND |
| Reactive silica | mg/L | — | — |
| Ammonia as N | mg/l | 16,100 | 96,000 |
| Nitrite as N | mg/l | 0.10 | <6.09 |
| Nitrate as N | mg/l | 5.04 | <4.52 |
| Nitrite + Nitrate as N | mg/l | 5.14 | <10.6 |
| Total Kjeldahl Nitrogen as N | mg/L | — | — |
| Total Nitrogen as N | mg/L | — | — |
| Total Phosphorus as P | mg/L | — | — |
| TOC | mg/l | 9.68 | 53.7 |
| Hydroxide Alkalinity | CaCO₃ mg/l | <1 | — |
| Carbonate Alkalinity | CaCO₃ mg/l | <1 | — |
| Bicarbonate Alkalinity | CaCO₃ mg/l | 1,450 | — |
| Total Alkalinity | CaCO₃ mg/l | 1,450 | — |

### Case Study 3:

The third case study used a feed liquid 11 from an evaporation cell with a pH of 5.9 and a TDS of 200,000 mg/L. The evaporation-cell sample is concentrated from a starting salinity of 19.5 w/w % to a concentration of 24.5 w/w % in the first reverse-osmosis assembly 14. The first reverse-osmosis assembly 14 is operated at room temperature, using 1,000 psi (6.9 MPa) operating pressure. Subsequently, the concentrate solution 17 from the first reverse-osmosis assembly 14 is de-supersaturated in the de-supersaturation module 28 using Na₂S as the seed, followed by further concentration using a second reverse-osmosis assembly 36. Further concentration of the de-supersaturated concentrate solution 34 using the second reverse-osmosis assembly 36 further concentrates the brine solution to a final concentration of 43 w/w %. Table 3, below, shows the analysis results for the untreated evaporation-cell sample and the concentrated brine 46 at 43 w/w %.

TABLE 3

| Parameter | Unit | Feed | Concentrate |
|---|---|---|---|
| pH | — | 5.9 | 5.9 |
| Conductivity | μS/cm | 439,100 | 616,000 |
| TDS | mg/l | 200,000 | 468,000 |
| TSS | mg/l | 47 | NA |
| Sulfate as SO4 | mg/l | 152,117 | 303,469 |
| Chloride as Cl | mg/l | 11,677 | 25,399 |
| Calcium as Ca | mg/l | 767 | 847 |
| Magnesium as Mg | mg/l | 133 | 130 |
| Sodium as Na | mg/l | 9,753 | 21,730 |
| Potassium as K | mg/l | 313 | 541 |
| Aluminium as Al | mg/l | 0.653 | 1.45 |
| Arsenic as As | mg/l | 8.85 | 15.0 |
| Beryllium as Be | mg/l | ND | ND |
| Barium as Ba | mg/l | 0.155 | 0.253 |
| Bismuth as Bi | mg/l | ND | ND |
| Cadmium as Cd | mg/l | ND | ND |
| Chromium as Cr | mg/l | 0.014 | 0.044 |
| Cobalt as Co | mg/l | 153 | 111 |
| Copper as Cu | mg/l | 67.2 | 116 |
| Lead as Pd | mg/l | 0.205 | 0.239 |
| Lithium as Li | mg/l | 0.386 | 0.199 |
| Manganese as Mn | mg/l | 7.63 | 14.5 |
| Molybdenum as Mo | mg/l | 0.361 | 0.558 |
| Nickel as Ni | mg/l | 639 | 123 |
| Selenium as Se | mg/l | 0.627 | 0.847 |
| Silver as Ag | mg/l | ND | 0.213 |
| Strontium as Sr | mg/l | 4.05 | 1.33 |
| Boron as B | mg/l | 20.2 | 27.5 |
| Iron as Fe | mg/l | ND | 0.789 |
| Reactive silica | mg/L | — | — |
| Ammonia as N | mg/l | 40,200 | 91,000 |
| Nitrite as N | mg/l | <0.1 | <0.03 |
| Nitrate as N | mg/l | 1.07 | 2,396 |
| Nitrite + Nitrate as N | mg/l | <1.08 | 2,396 |
| Total Kjeldahl Nitrogen as N | mg/L | — | — |
| Total Nitrogen as N | mg/L | — | — |
| Total Phosphorus as P | mg/L | — | — |
| TOC | mg/l | 118 | 211 |
| Hydroxide Alkalinity | CaCO₃ mg/l | <1 | <2 |
| Carbonate Alkalinity | CaCO₃ mg/l | <1 | <2 |
| Bicarbonate Alkalinity | CaCO₃ mg/l | 275 | 380 |
| Total Alkalinity | CaCO₃ mg/l | 275 | 380 |

In describing embodiments, herein, specific terminology is used for the sake of clarity. For the purpose of description, specific terms are intended to at least include technical and functional equivalents that operate in a similar manner to accomplish a similar result. Additionally, in some instances where a particular embodiment includes a plurality of system elements or method steps, those elements or steps may be replaced with a single element or step. Likewise, a single element or step may be replaced with a plurality of elements or steps that serve the same purpose. Further, where parameters for various properties or other values are specified herein for embodiments, those parameters or values can be adjusted up or down by 1/100^{th}, 1/50^{th}, 1/20^{th}, 1/10^{th}, ⅕^{th}, ⅓^{rd}, ½, ⅔^{rd}, ¾^{th}, ⅘^{th}, 9/10^{th}, 19/20^{th}, 49/50^{th}, 99/100^{th}, etc. (or up by a factor of 1, 2, 3, 4, 5, 6, 8, 10, 20, 50, 100, etc.), or by rounded-off approximations thereof or within a range of the specified parameter up to or down to any of the variations specified above (e.g., for a specified parameter of 100 and a variation of 1/100^{th}, the value of the parameter may be in a range from 0.99 to 1.01), unless otherwise specified. Further still, where methods are recited and where steps/stages are recited in a particular order—with or without sequenced prefacing characters added for ease of reference—the steps/stages are not to be interpreted as being temporally limited to the order in which they are recited unless otherwise specified or implied by the terms and phrasing.

Additional examples consistent with the present teachings are set out in the following numbered clauses:
1. A method for concentrating a dissolved species from a feed liquid, the method comprising:
   passing the feed liquid including the dissolved species into a first reverse-osmosis module of a first reverse-osmosis assembly;
   in the first reverse-osmosis module, separating the feed liquid with a membrane, wherein a permeate flows through the membrane to a permeate side of the reverse-osmosis module, while a concentrate solution is retained on a retentate side on an opposite side of the membrane from the permeate side in the first reverse-osmosis module;
   passing the permeate from the permeate side of the first reverse-osmosis module of the first reverse-osmosis assembly to a polishing module;
   passing the concentrate solution from the retentate side of the first reverse-osmosis module of the first reverse-osmosis assembly to a de-supersaturation module;
   in the de-supersaturation module, precipitating dissolved components from the concentrate solution to produce solid precipitates and a de-supersaturated concentrate solution;
   discharging the solid precipitates from the de-supersaturation module;
   passing the de-supersaturated concentrate solution from the de-supersaturation module to a first reverse-osmosis module of a second reverse-osmosis assembly;
   in the first reverse-osmosis module of the second reverse-osmosis assembly, separating the de-supersaturated concentrate solution with a membrane, wherein a permeate flows through the membrane to a permeate side of the second reverse-osmosis module, while a concentrated brine is retained on a retentate side on an opposite side of the membrane from the permeate side of the first reverse-osmosis module of the second reverse-osmosis module assembly;
   passing the permeate from the permeate side of the first reverse-osmosis module of the second reverse-osmosis assembly to the polishing module;
   extracting the concentrated brine from the second reverse-osmosis module;
   in the polishing module, further purifying the permeate from the first and second reverse-osmosis assemblies to produce a polished permeate and a concentrate solution that is less pure than the polished permeate;
   recycling the concentrate solution from the polishing module back to the retentate side of the first reverse-osmosis module of the first reverse-osmosis assembly where the concentrate solution from the polishing module mixes with the feed liquid; and
   extracting the polished permeate from the polishing module.
2. The method of clause 1, wherein the dissolved species comprises a sulfur compound in dissolved form.
3. The method of clause 1, wherein the sulfur compound is ammonium sulfate.
4. The method of any of clauses 1-3, wherein the feed liquid is a brine comprising at least one of nickel and cobalt from a mine.
5. The method of any of clauses 1-4, wherein the first reverse-osmosis module is a counter-flow reverse-osmosis module with flow in opposite directions on opposite sides of the membrane.
6. The method of any of clauses 1-5, further comprising passing a sweep solution through the permeate side of the first reverse-osmosis module.
7. The method of any of clauses 1-6, wherein the de-supersaturation module is selected from:
   (a) a precipitation tank and
   (b) a fluidized bed reactor
   in which the concentrate solution from the first reverse-osmosis assembly is seeded to initiate precipitation of dissolved components in the concentrate solution.
8. The method of any of clauses 1-7, wherein the polishing module is a reverse-osmosis module.
9. The method of any of clauses 1-8, further comprising passing the permeate or the concentrate solution from the first reverse-osmosis module of the first reverse-osmosis assembly through a retentate side of a second reverse-osmosis module of the first reverse-osmosis assembly and passing a portion of the permeate or concentrate solution from the first reverse-osmosis module of the first reverse-osmosis assembly through a membrane to a permeate side of the second reverse-osmosis module before passing to the polishing module.
10. The method of any of clauses 1-9, further comprising passing the permeate or the concentrated brine from the first reverse-osmosis module of the second reverse-osmosis assembly through a retentate side of a second reverse-osmosis module of the second reverse-osmosis assembly and passing a portion of the permeate or concentrated brine from the first reverse-osmosis module of the second reverse-osmosis assembly through a membrane to a permeate side of the second reverse-osmosis module before passing to the polishing module.
11. A system for concentrating a dissolved species from a feed liquid, the system comprising:
   a source of feed liquid including the dissolved species;
   a first reverse-osmosis assembly and a second reverse-osmosis assembly, wherein each reverse-osmosis assembly includes a first reverse-osmosis module that defines a chamber and includes (a) a membrane contained in the chamber and dividing the chamber into a permeate side and a retentate side, wherein the membrane is configured to selectively pass solvent from a feed liquid from the retentate side through the membrane to the permeate side; (b) an inlet configured for liquid flow into the retentate side; (c) an outlet on the retentate side for releasing a concentrate solution; and (d) a permeate outlet on the permeate side for releasing the permeate, wherein the first reverse-osmosis module of the first reverse-osmosis assembly is configured to receive the feed liquid from the source of feed liquid, wherein the membrane of the first reverse-osmosis module of the first reverse-osmosis assembly is configured to selectively pass solvent from the feed liquid in the retentate side through the membrane to the permeate side of the first reverse-osmosis module of the first reverse-osmosis assembly;
   a de-supersaturation module configured to precipitate solids from the concentrate solution from the first reverse-osmosis assembly to produce precipitated solids and a de-supersaturated concentrate solution, the de-supersaturation module including a de-supersaturation inlet in fluid communication with the retentate outlet of the first reverse-osmosis module of the first reverse-osmosis assembly and configured to receive the concentrate solution from the retentate outlet of the first reverse-osmosis module of the first reverse-osmosis assembly, a precipitate outlet for releasing the precipitated solids, and a de-supersaturated-concentrate outlet for releasing the de-supersaturated concentrate solution from the de-supersaturation module, wherein the first reverse-osmosis module of the second reverse-osmosis assembly configured to receive the de-supersaturated concentrate solution from the de-supersaturation module, and wherein the membrane of the first reverse-osmosis module of the second reverse-osmosis assembly is configured to configured to selectively pass solvent from the de-supersaturated concentrate solution in the retentate side through the membrane to the permeate side of the first reverse-osmosis module of the second reverse-osmosis assembly; and
   a polishing module including a polishing inlet in fluid communication with the permeate outlet of the first reverse-osmosis module of each of the first and second reverse-osmosis assemblies, wherein the polishing module is configured to receive the permeate of the first and second reverse-osmosis assemblies and to further purify the permeates produce a polished liquid as well as a concentrate solution, a polished-liquid outlet for releasing the polished liquid, and a concentrate outlet in fluid communication with the inlet of the first reverse-osmosis module of the first reverse-osmosis assembly for recycling the concentrate solution from the polishing module back to the first reverse-osmosis assembly.
12. The system of clause 11, wherein the first reverse-osmosis module is a counter-flow reverse-osmosis module configured for flow in opposite directions on opposite sides of the membrane.
13. The system of clause 12, wherein the first reverse-osmosis assembly further comprises a second reverse-osmosis module that defines a chamber and includes a membrane contained in the chamber and dividing the chamber into a permeate side and a retentate side, wherein the second reverse-osmosis module is configured to receive the permeate or the concentrate solution from the first reverse-osmosis module of the first reverse-osmosis assembly on the retentate side of the second reverse-osmosis assembly and to pass a permeate from the permeate side or a retentate from the retentate side of the second reverse-osmosis assembly to the permeate side of the first reverse-osmosis module of the second reverse-osmosis assembly.
14. The system of clause 13, wherein the de-supersaturation inlet of the de-supersaturation module is configured to receive the concentrate solution from the retentate side of the second reverse-osmosis module.
15. The system of clause 12, wherein the second reverse-osmosis assembly further comprises a second reverse-osmosis module that defines a chamber and includes a membrane contained in the chamber and dividing the chamber into a permeate side and a retentate side, wherein the second reverse-osmosis module is configured to receive the permeate or the concentrate solution from the first reverse-osmosis module of the second reverse-osmosis assembly on the retentate side of the second reverse-osmosis assembly and to pass a permeate from the permeate side or a retentate from the retentate side of the second reverse-osmosis assembly to the permeate side of the first reverse-osmosis module of the second reverse-osmosis assembly.
16. The system of clause 12, wherein the system is configured for a sweep solution to pass through the permeate side of the first reverse-osmosis module.
17. The system of any of clauses 11-16, wherein the de-supersaturation module is selected from:
   (a) a precipitation tank and
   (b) a fluidized bed reactor
   configured to seed the concentrate solution from the first reverse-osmosis module of the first reverse-osmosis assembly to initiate precipitation of dissolved components in the concentrate solution from the first reverse-osmosis assembly.
18. The system of any of clauses 11-17, wherein the polishing module is a reverse-osmosis module.
19. The system of any of clauses 11-18, wherein the dissolved species includes comprises a sulfur compound in dissolved form.

While this invention has been shown and described with references to particular embodiments thereof, those skilled in the art will understand that various substitutions and alterations in form and details may be made therein without departing from the scope of the invention. Further still, other aspects, functions, and advantages are also within the scope of the invention; and all embodiments of the invention need not necessarily achieve all of the advantages or possess all of the characteristics described above. Additionally, steps, elements, and features discussed herein in connection with one embodiment can likewise be used in conjunction with other embodiments. The contents of references, including reference texts, journal articles, patents, patent applications, etc., cited throughout the text are hereby incorporated by reference in their entirety for all purposes; and all appropriate combinations of embodiments, features, characterizations, and methods from these references and the present disclosure may be included in embodiments of this invention. Still further, the components and steps identified in the Background section are integral to this disclosure and can be used in conjunction with or substituted for components and steps described elsewhere in the disclosure within the scope of the invention.

1. A method for concentrating a dissolved species from a feed liquid, the method comprising:
passing the feed liquid including the dissolved species into a first reverse-osmosis module of a first reverse-osmosis assembly;
in the first reverse-osmosis module, separating the feed liquid with a membrane, wherein a permeate flows through the membrane to a permeate side of the reverse-osmosis module, while a concentrate solution is retained on a retentate side on an opposite side of the membrane from the permeate side in the first reverse-osmosis module;
passing the permeate from the permeate side of the first reverse-osmosis module of the first reverse-osmosis assembly to a polishing module;
passing the concentrate solution from the retentate side of the first reverse-osmosis module of the first reverse-osmosis assembly to a de-supersaturation module;
in the de-supersaturation module, precipitating dissolved components from the concentrate solution to produce solid precipitates and a de-supersaturated concentrate solution;
discharging the solid precipitates from the de-supersaturation module;
passing the de-supersaturated concentrate solution from the de-supersaturation module to a first reverse-osmosis module of a second reverse-osmosis assembly;
in the first reverse-osmosis module of the second reverse-osmosis assembly, separating the de-supersaturated concentrate solution with a membrane, wherein a permeate flows through the membrane to a permeate side of the second reverse-osmosis module, while a concentrated brine is retained on a retentate side on an opposite side of the membrane from the permeate side of the first reverse-osmosis module of the second reverse-osmosis module assembly;
passing the permeate from the permeate side of the first reverse-osmosis module of the second reverse-osmosis assembly to the polishing module;
extracting the concentrated brine from the second reverse-osmosis module;
in the polishing module, further purifying the permeate from the first and second reverse-osmosis assemblies to produce a polished permeate and a concentrate solution that is less pure than the polished permeate;
recycling the concentrate solution from the polishing module back to the retentate side of the first reverse-osmosis module of the first reverse-osmosis assembly where the concentrate solution from the polishing module mixes with the feed liquid; and
extracting the polished permeate from the polishing module.

2. The method of claim 1, wherein the dissolved species comprises a sulfur compound in dissolved form.

3. The method of claim 2, wherein the sulfur compound is ammonium sulfate.

4. The method of claim 3, wherein the feed liquid is a brine comprising at least one of nickel and cobalt from a mine.

5. The method of claim 1, wherein the first reverse-osmosis module is a counter-flow reverse-osmosis module with flow in opposite directions on opposite sides of the membrane.

6. The method of claim 5, further comprising passing a sweep solution through the permeate side of the first reverse-osmosis module.

7. The method of claim 1, wherein the de-supersaturation module is selected from:
(a) a precipitation tank and
(b) a fluidized bed reactor
in which the concentrate solution from the first reverse-osmosis assembly is seeded to initiate precipitation of dissolved components in the concentrate solution.

8. The method of claim 1, wherein the polishing module is a reverse-osmosis module.

9. The method of claim 1, further comprising passing the permeate or the concentrate solution from the first reverse-osmosis module of the first reverse-osmosis assembly through a retentate side of a second reverse-osmosis module of the first reverse-osmosis assembly and passing a portion of the permeate or concentrate solution from the first reverse-osmosis module of the first reverse-osmosis assembly through a membrane to a permeate side of the second reverse-osmosis module before passing to the polishing module.

10. The method of claim 1, further comprising passing the permeate or the concentrated brine from the first reverse-osmosis module of the second reverse-osmosis assembly through a retentate side of a second reverse-osmosis module of the second reverse-osmosis assembly and passing a portion of the permeate or concentrated brine from the first reverse-osmosis module of the second reverse-osmosis assembly through a membrane to a permeate side of the second reverse-osmosis module before passing to the polishing module.

11-19. (canceled)
